(19) United States
(12) Patent Application Publication
(10) Pub. No.: US 2009/0027381 A1
(43) Pub. Date: Jan. 29, 2009

(54) THREE-DIMENSIONAL CONTENT REPRODUCTION APPARATUS AND METHOD OF CONTROLLING THE SAME

(75) Inventor: Moon-sang LEE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/026,562

(22) Filed: Feb. 6, 2008

(30) Foreign Application Priority Data
Jul. 23, 2007 (KR) 10-2007-0073507

(51) Int. Cl. G06T 15/00; G09G 5/00

(52) U.S. Cl. 345/419; 345/156; 345/204; 348/E13.022; 348/E13.031

(57) ABSTRACT

Provided are a spherical three-dimensional (3D) content reproduction apparatus and a method of controlling the same. The 3D content reproduction apparatus includes: a spherical display device which reproduces 3D content; and a docking station which provides 3D content, or the 3D content and metadata of the 3D content received from one of a web server and a storage unit to the spherical display device. The docking station includes a detecting unit which detects whether the spherical display device is attached to or detached from the docking station, and transmits a detection result to the spherical display device.

### CROSS-REFERENCE TO RELATED PATENT APPLICATION

This application claims priority from Korean Patent Application No. 10-2007-0073507, filed on Jul. 23, 2007 in the Korean Intellectual Property Office, the disclosure of which is incorporated herein in its entirety by reference.

### BACKGROUND OF THE INVENTION

1. Field of the Invention

Apparatuses and methods consistent with the present invention relate to content reproduction, and more particularly, to three-dimensional content reproduction.

2. Description of the Related Art

Three-dimensional (3D) content reproduction apparatuses reproduce a 3D image to provide a stereoscopic image.

Numerous attempts have been made to obtain a stereoscopic image since polarization technique was developed in the 1920s. Optical holograms were developed in the 1940s, laser holograms were developed in the 1960s, polarized glasses and anaglyph glasses used to view a stereoscopic movie were developed in the 1980s, head-mounted displays were developed in the 1990s, and glassless 3D content reproduction apparatuses have been actively studied in recent years. Glassless 3D content reproduction apparatuses enable a user to see a 3D stereoscopic image without wearing viewing aids, such as specially-designed glasses, by controlling the direction of travel of light emitted from a display or refracting the light.

Most of currently suggested 3D content reproduction apparatuses are rectangular display devices such as liquid crystal display (LCD) monitors or plasma display panels (PDP).

### SUMMARY OF THE INVENTION

The present invention provides a spherical 3D content reproduction apparatus and a method of controlling the same.

According to an aspect of the present invention, there is provided a 3D content reproduction apparatus comprising: a spherical display device reproducing 3D content; and a docking station providing 3D content, or the 3D content and metadata of the 3D content received from one of a web server and a storage unit to the spherical display device, wherein the docking station comprises a detecting unit detecting whether the spherical display device is attached to or detached from the docking station, and transmitting the detection result to the spherical display device.

The spherical display device may be driven based on movement of the spherical display device, or the movement and touch of the spherical display device.

If it is determined that 3D content to be displayed is for users under a predetermined age, the spherical display device may further output a low-pitched sound of a predetermined frequency.

If information indicating that the spherical display device is detached from the docking station is received, the spherical display device may be turned off

The spherical display device may further display 3D select information on reproducible 3D content items.

If the 3D content reproduction apparatus is a 3D electronic book (e-book) device, the 3D content may be 3D e-book data and the 3D select information may be information on selectable 3D e-books.

If the spherical display device is detached from the docking station and the movement of the display device is detected, the spherical display device may display one of a 3D moving image and a 3D still image which are previously stored.

The spherical display device may further output audio data.

If a timer mode for the spherical display device is set and the spherical display device is not moved or touched for a predetermined period of time, the spherical display device may be turned off.

The spherical display device may comprise: a user input analyzing unit analyzing a user's input based on the movement of the spherical display device, or the movement and touch of the spherical display device; a wireless communication unit wirelessly communicating with the docking station; a storage unit storing the 3D content and audio data corresponding to the 3D content; a display unit displaying the 3D content in three-dimensions; an audio output unit outputting the audio data; and a control unit controlling the functions of the display device.

The storage unit may further store at least one of a 3D moving image and a 3D still image, wherein, when the spherical display device is detached from the docking station and then the movement of the spherical display device is detected by the user input analyzing unit, the control unit controls the display unit to display one of the 3D moving image and the 3D still image thereon.

According to another aspect of the present invention, there is provided a method of controlling a 3D content reproduction apparatus comprising: a spherical display device reproducing 3D content; and a docking station, the method comprising: receiving 3D content, or the 3D content and metadata from one of a web server and a storage unit, and storing the 3D content, or the 3D content and the metadata in the docking station; when the 3D content is requested by the spherical display device, transmitting the 3D content, or the 3D content and the metadata stored in the docking station to the spherical display device; and controlling the spherical display device to reproduce the 3D content based on a control signal input by the docking station and the movement of the spherical display device or the movement and the touch of the spherical display device.

According to another aspect of the present invention, there is provided a 3D content reproduction apparatus comprising: a spherical display device reproducing 3D content; and a docking station which the spherical display device is mounted, wherein the spherical display device receives 3D content, or the 3D content and metadata of the 3D content from one of a web server and a storage unit.

According to another aspect of the present invention, there is provided a method of controlling a 3D content reproduction apparatus comprising: a spherical display device reproducing 3D content; and a docking station, the method comprising: receiving 3D content, or the 3D content and metadata from one of a web server and a storage unit using the spherical display device; and controlling the spherical display device to reproduce the 3D content based on a control signal input by the docking station and the movement of the spherical display device or the movement and touch of the spherical display device.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a 3D content reproduction apparatus according to an embodiment of the present invention;

FIG. 2 is a block diagram of a display device and a docking station of the 3D content reproduction apparatus of FIG. 1;

FIGS. 3A and 3B illustrate 3D select information displayed on the display device of the 3D content reproduction apparatus of FIG. 1;

FIG. 4 is a block diagram illustrating paths through which 3D content is obtained by the 3D content reproduction apparatus of FIG. 1, according to an embodiment of the present invention; and

FIG. 5 is a flowchart illustrating a method of controlling the 3D content reproduction apparatus of FIG. 1, according to an embodiment of the present invention.

### DETAILED DESCRIPTION OF EXEMPLARY EMBODIMENTS OF THE INVENTION

Exemplary embodiments of the present invention will now be described more fully with reference to the accompanying drawings.

Exemplary embodiments of the present invention provide a spherical 3D content reproduction apparatus including a spherical display device and a docking station, and a method of controlling the spherical 3D content reproduction apparatus. In particular, the functions of the 3D content reproduction apparatus can be controlled based on the movement of the spherical 3D display device, or the movement and touch of the spherical 3D display device. Also, 3D content, or the 3D content and metadata of the 3D content may be obtained from a web server or a movable storage unit, or 3D content or, the 3D content and metadata of the 3D content obtained from a web server may be stored in a movable storage unit. While 3D content, or the 3D content and metadata of the 3D content are received from a web server or a movable storage unit using the docking station in the present exemplary embodiment, they may be received using the spherical display device.

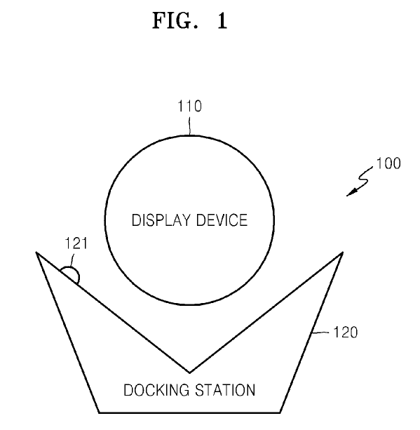

FIG. 1 is a schematic view of a 3D content reproduction apparatus 100 according to an exemplary embodiment of the present invention. Referring to FIG. 1, the 3D content reproduction apparatus 100 includes a display device 110 and a docking station 120. The docking station 120 includes an attachment/detachment detecting unit 121 which detects whether the display device 110 is attached to or detached from the docking station 120.

The display device 110 has a spherical shape, and reproduces or displays 3D content. Generally, 3D content has a same format as modeling data used in 3D animation. That is, 3D content may include information on wireframes of objects to be represented, resource files describing the materials/colors of the respective wire-frames, a moving path and brightness of light sources over time, and motions and position change of the objects over time.

The display device 110 is driven based on a movement of the display device 110, or the movement and touch of the display device 110. For example, a function, such as power on/off, may be controlled by rotating the display device 110 forward and backward, and functions, such as 3D content rewind and 3D content fast forward, may be controlled by rotating the display device 110 leftward and rightward.

The display device 110 may further output a sound of a predetermined frequency, when it is determined that 3D content to be displayed is intended for users under a predetermined age. When information indicating that the display device 110 is detached from the docking station 120 is received, the display device 110 may be turned off The display device 110 may further display 3D select information on reproducible 3D content. When the display device 110 is detached from the docking station 120 and then the movement of the display device 110 is detected, the display device 110 may display one of a 3D moving image and a 3D still image which are previously stored.

Further, the display device 110 may output audio data corresponding to reproduced 3D content. Also, when a timer mode is set by the docking station 120 and then the display device 110 is not moved or touched for a predetermined period of time, e.g., 30 minutes, the display device 110 may be turned off

The display device 110 may have two surfaces and the outer surface of the display device 110 may be formed of a flexible material like a ball.

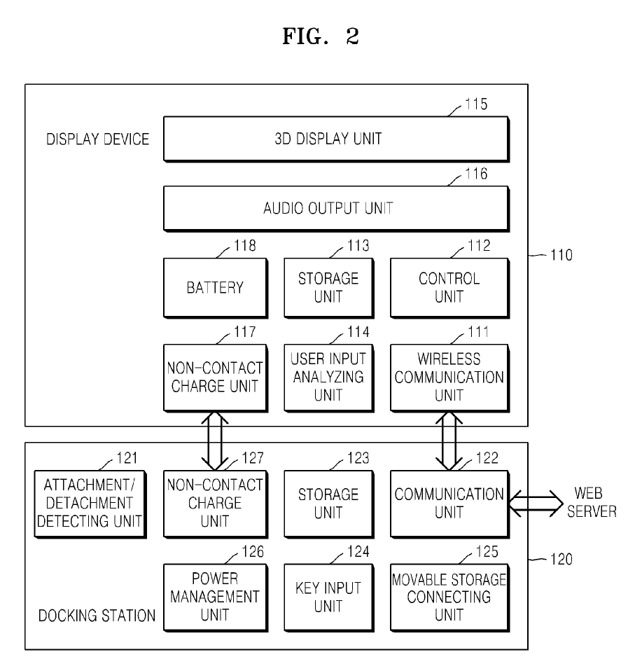

FIG. 2 is a block diagram of the display device 110. Referring to FIG. 2, the display device 110 includes a wireless communication unit 111, a control unit 112, a storage unit 113, a user input analyzing unit 114, a 3D display unit 115, an audio output unit 116, a non-contact charge unit 117, and a battery 118.

The wireless communication unit 111 wirelessly communicates with the docking station 120, such that the wireless communication unit 111 transmits a 3D content request signal to the docking station 120. The 3D content request signal may be produced based on the 3D select information or by a 3D content reproduction request. The 3D content request signal may be input by the user input analyzing unit 114.

The wireless communication unit 111 may receive from the docking station 120 3D content, the 3D content and metadata of the 3D content, the metadata of the 3D content, a user control signal, and a detection result indicating whether the display device 110 is detached from the docking station 120.

The control unit 112 controls the functions of the display device 110. When it is analyzed by the user input analyzing unit 114 that 3D content is requested, the control unit 112 transmits a 3D content request signal to the docking station 120 via the wireless communication unit 111. When the control unit 112 receives 3D content, or the 3D content and metadata of the 3D content via the wireless communication unit 111, the control unit 112 stores the 3D content, or the 3D content and the metadata of the 3D content in the storage unit 113.

In particular, when 3D content and metadata of the 3D content are received, the control unit 112 may analyze the received metadata, and when it is determined that reproducible 3D content is intended for users under a predetermined age, the control unit 112 may control the audio output unit 115 to further output a sound of a predetermined frequency, e.g., a low-pitched sound. The predetermined frequency of the sound may be the same frequency as the heart rate of a person, and the predetermined age may be set to five years old so that the 3D content reproduced by the display device 110 can be watched by infants comfortably.

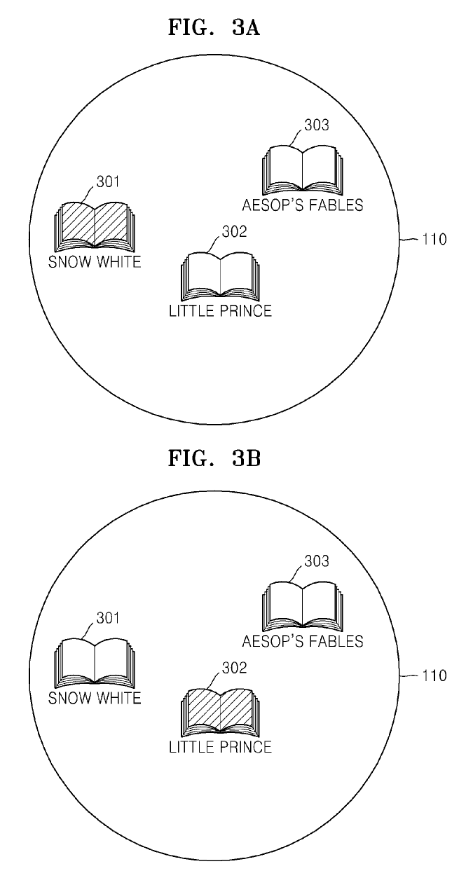

When only metadata of a plurality of 3D content items are received, the control unit 112 may analyze the received metadata, provide 3D select information on selectable 3D content items to the 3D display unit 115, and display the selectable 3D content items as shown in FIG. 3A.

FIG. 3A illustrates selectable 3D content items when 3D content is an electronic book (e-book) data and there are three selectable 3D content items. 3D select information on the selectable 3D content items may be displayed as floating in 3D space over the upper surface of the display device 110 as shown in FIG. 3A. The control unit 112 may control the 3D display unit 115 to change a selected item based on a direction in which the display device 110 is rotated. That is, in the state where a Snow White e-book 301 is selected and highlighted as shown in FIG. 3A, a selected item may be changed to a Little Prince e-book 302 by rotating leftward the display device 110 as shown in FIG. 3B. When the Little Prince e-book 302 is highlighted as shown in FIG. 3B and it is determined that a corresponding point is touched, the control unit 112 analyzes that the Little Prince e-book 302 is selected and transmits the analysis result to the docking station 120 by means of the wireless communication unit 111. Accordingly, when 3D content regarding the Little Prince is received from the docking station 120, the control unit 112 stores the received 3D content regarding the Little Prince in the storage unit 113 and outputs the stored 3D content regarding the Little Prince to the 3D display unit 115. When audio data corresponding to the 3D content exists, the control unit 112 outputs the audio data to the audio output unit 116. The control unit 112 may control the audio output unit 116 to output a low-pitched sound having a predetermined frequency as well.

When information indicating that the display device 110 is detached from the docking station 120 is received from the wireless communication unit 111, the control unit 112 turns off the display device 11. In this state, when the movement of the display device 110 is detected by the user input analyzing unit 114, one of a 3D moving image and a 3D still image which are stored previously in the storage unit 113 is displayed on the 3D display unit 115. The 3D moving image or the 3D still image stored in the storage unit 113 may be stored in the storage unit 113 while the display device 110 is manufactured. Also, the control unit 112 may receive a new 3D moving image or 3D still image from the docking station 120 and store the same in the storage unit 113 or update the 3D moving image or the 3D still image previously stored in the storage unit 113.

When a signal indicating that a timer mode is set is received from the wireless communication unit 111 and then no signal is received from the user input analyzing unit 114 for a predetermined period of time, e.g., 30 minutes, the control unit 112 may turn off the display device 110. The state where no signal is received from the user input analyzing unit 114 means that the display device 110 is not controlled at all.

When the display device 110 is attached to the docking station 120 and then the touch or movement of the display device 110 is detected by the user analyzing unit 114, the control unit 112 may turn on the display device 110 and request 3D content or information on the 3D content from the docking station 120.

The storage unit 113 stores 3D content, the 3D content and metadata of the 3D content, and the 3D moving image or 3D still image received from the wireless communication unit 111. The storage unit 113 may be a storage device such as a flash memory.

The user input analyzing unit 114 analyzes a user input based on the movement of the display device 110, or the movement and touch of the display device 110, and provides the analysis result to the control unit 112. Accordingly, the control unit 112 can determine whether the display device 110 is moved and touched.

The 3D display unit 115 displays 3D content or 3D select information on the 3D content. That is, the 3D content display unit 115 may display 3D content and 3D select information using one of holography, variable-focus mirror display, rotating-screen display, translation-screen display, integral photography, and volumetric display.

The audio output unit 116 outputs audio data corresponding to 3D content that is currently displayed. In particular, when reproduced 3D content is for users under a predetermined age, the audio output unit 116 is controlled by the control unit 112 to output a low-pitched sound of a predetermined frequency in addition to the audio data corresponding to the 3D content for users under a predetermined age.

When the display device 110 is attached to the docking station 120, the non-contact charge unit 117 charges the battery 118 with a voltage transmitted in a non-contact manner from the docking station 120 to supply power to the display device 110.

The docking station 120 in FIG. 1 may include the attachment/detachment detecting unit 121 to detect whether the display device 110 is attached to or detached from the docking station 120, and a recess in which the spherical display device 110 can be stably mounted. The docking station 120 transmits 3D content, or the 3D content and metadata of the 3D content received from a web server (not shown) or a movable storage unit (not shown) to the display device 110 in response to a request by the display device 110.

The docking station 120 transmits a control signal input by a user to the display device 110. When select information on desired 3D content is received from the display device 110, the docking station 120 receives corresponding 3D content from the web server or the movable storage unit and transmits the same to the display device 110.

FIG. 2 also shows a block diagram of the docking station 120. Referring to FIG. 2, the docking station 120 includes the attachment/detachment detecting unit 121, a communication unit 122, a storage unit 123, a key input unit 124, a movable storage connecting unit 125, a power management unit 126, and a non-contact charge unit 127.

The attachment/detachment detecting unit 121 detects whether the display device 110 is attached to or detached from the docking station 120, and transmits the detection result to the communication unit 122. To detect whether the display device 110 is attached to or detached from the docking station 120, the attachment/detachment detecting unit 121 may include a switch or a sensor which is turned on when the display device 110 is attached to the docking station 120 and is turned off when the display device 110 is detached from the docking station 120. For example, the sensor may be a press sensor.

The communication unit 122 communicates with the web server to download 3D content, the 3D content and metadata of the 3D content, or the metadata of the 3D content, and stores the downloaded data in the storage unit 123. When 3D information or information on the 3D content is requested by means of the wireless communication unit 111 of the display unit 110, the 3D content, the metadata of the 3D content, or the 3D content and the metadata of the 3D content stored in the storage unit 123 are transmitted to the wireless communication unit 111. If metadata of selectable 3D contents are received from the web server and transmitted to the wireless communication unit 111 of the display unit 110, and select information is received from the wireless communication unit 111, the communication unit 122 downloads a selected 3D content from the web server and transmits the downloaded 3D content to the wireless communication unit 111. Accordingly, the display device 110 reproduces the selected 3D content.

Also, the communication unit 122 transmits a signal indicating whether the display device 110 is attached to or detached from the docking station 120 received from the attachment/detachment detecting unit 121 to the wireless communication unit 111 of the display device 110, and transmits a user control signal input through the key input unit 124 to the wireless communication unit 111. The user control signal input through the key input unit 124 is a control signal related to the reproduction of 3D content. The control signal related to the reproduction of the 3D content may include a signal for controlling functions, such as 3D content reproduction, rewind, fast forward, and power on/off, and a signal for setting a timer mode.

The storage unit 123 stores 3D content and metadata of the 3D content received from the communication unit 122.

The movable storage connecting unit 125 is connected to the movable storage unit, and reads 3D content stored in the movable storage unit or stores 3D content in the movable storage unit. The movable storage unit may be a flash memory card, a USB memory, a digital versatile disc (DVD), or a compact disc (CD). When the 3D content reproduction apparatus 100 is a 3D e-book device, the movable storage unit may be a 3D e-book pack.

The power management unit 126 manages the power of the display device 110 as well as the power of the docking station 120.

When the display device 110 is attached to the docking station 120, the non-contact charge unit 127 cooperates with the non-contact charge unit 117 of the display device 110 to transmit a voltage provided from the power management unit 126 to the display device 110 and charge the battery 118 of the display device 110.

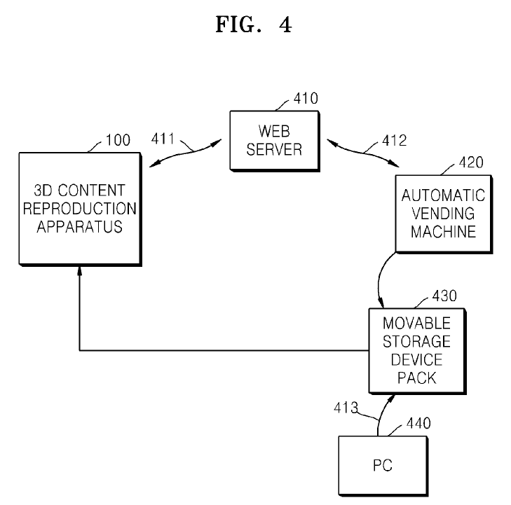

FIG. 4 is a block diagram illustrating paths through which the docking station 110 may obtain 3D content by the 3D content reproduction apparatus of FIG. 1, according to an exemplary embodiment of the present invention. That is, the docking station 110 may download 3D content from a web server 410 through a network 411. The downloaded 3D content may be stored in the storage unit 123 of the docking station 120, or stored in a movable storage unit connected to the movable storage connecting unit 125. Also, when the web server 410 sells 3D content, which is provided online or offline, as a movable storage device pack 430 in an automatic vending machine 420 via a path 412, a user may buy the movable storage device pack 430 and view the 3D content by inserting the movable storage device pack 430 into the movable storage connecting unit 125 of the docking station 120. The movable storage device pack 430 may allow a buyer to store on the spot therein data corresponding to a 3D content selected from the automatic vending machine 420. The movable storage device pack 430 may be only for 3D content, and may be a flash memory, a DVD, or a CD.

The movable storage device pack 430 may allow a user to directly store therein 3D content which is built by the user himself/herself using a personal computer (PC) 440 with a 3D-toolkit, and the movable storage device pack 430 may be connected to the movable storage connecting unit 125 of the docking station 120 for use.

While 3D content, or the 3D content and metadata of the 3D content are received from the web server or the movable storage unit using the docking station 120 in FIGS. 1 through 4, 3D content, or the 3D content and metadata of the 3D content may be received from the web server or the movable storage unit using the display device 110. In the latter case, the display device 110 may be modified to have functions corresponding to those of the communication unit 122, the storage unit 123, and the movable storage connecting unit 125 of the docking station 120 of FIG. 2. For example, the wireless communication unit 111 may be modified to have the function of the communication unit 122, and the storage unit 113 may be modified to have the function of the storage unit 123. The display device 110 may be modified to additionally have the function of the movable storage connecting unit 125.

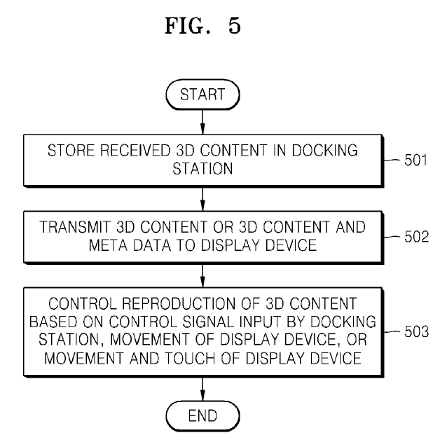

FIG. 5 is a flowchart illustrating a method of controlling the 3D content reproduction apparatus 100 of FIG. 1, according to an exemplary embodiment of the present invention.

In operation 501, when 3D content, or the 3D content and metadata are received from the web server or the movable storage unit, the docking station 120 stores the 3D content, or the 3D content and the metadata in the storage unit 123.

In operation 502, when 3D content is requested by the display device 110 attached to the docking station 120, the 3D content, or the 3D content and the metadata stored in the docking station 120 are transmitted to the display device 110. Accordingly, the display device 110 may output 3D select information on selectable 3D contents as shown in FIG. 3.

In operation 503, the reproduction of 3D content by the display device 110 is controlled based on a control signal input by the docking station 120, the movement of the display device 110, or the movement and touch of the display device 110.

The controlling of the reproduction of the 3D content in operation 503 may be performed in various ways as described above with reference to FIGS. 1 through 3.

That is, in operation 503, when it is determined whether and that 3D content to be reproduced is for users under a predetermined age, a low-pitched sound of a predetermined frequency may further be output from the display device 110 as described with reference to FIG. 1.

Also, in operation 503, when it is determined whether and that the display device 110 is detached from the docking station 120, the display device 110 may be turned off.

In operation 503, when it is monitored whether and determined that the display device 110 is detached from the docking station 120 and then moved, one of a 3D moving image and a 3D still image, which are previously stored, may be displayed on the display device 110.

In operation 503, when audio data corresponding to reproduced 3D content exist, the audio data may be output at the same time when the 3D content is reproduced.

In operation 503, when a timer mode is set and the display device 110 is not rotated or touched for a preset period of time, e.g., 30 minutes, the display device 110 may be turned off.

While the method controls the 3D content reproduction apparatus 100 to receive 3D content, or the 3D content and metadata of the 3D content from the web server or the movable storage unit using the docking station 120 in FIG. 5, the method may control the 3D content reproduction apparatus 100 to receive 3D content, or the 3D content and metadata of the 3D content using the display device 110. In the latter case, operations 501 and 502 of FIG. 5 may be modified such that 3D content, or the 3D content and metadata of the 3D content received by the display device 110 is stored in the display device 110.

The 3D content reproduction apparatus 100 of FIGS. 1 through 5 may be used as a 3D e-book device. In this case, currently reproduced 3D content may be moved to a previous page (or chapter) and a next page (or chapter) by rolling, touching, or rubbing the display device 110. For example, whether 3D content rewind or transfer to a previous page (or chapter) may be determined according to the amount of rightward rotation of the display device 110. The movement of the display device 110 may be the rolling or rotation of the display device 110.

A program for performing a method of controlling a 3D content reproduction apparatus according to an exemplary embodiment of the present invention may be embodied as computer readable codes on a computer readable recording medium. The computer readable recording medium may be any data storage device that can store data which can be thereafter read by a computer system. Examples of the computer readable recording medium include read-only memories (ROMs), random-access memories (RAMs), CD-ROMs, magnetic tapes, floppy disks, and optical data storage devices. The computer readable recording medium can be dispersively installed in a computer system connected to a network, and stored and executed as a computer readable code in a distributed computing environment.

Since the 3D content reproduction apparatus provides a user interface based on the movement of the spherical display device, or the movement and touch of the spherical display device, the 3D content reproduction apparatus can be more intuitive and easy to use.

For example, functions such as 3D content reproduction, 3D content rewind, 3D content fast forward, and power on/off can be controlled by touching or rotating the spherical 3D display device.

In addition, the 3D content reproduction apparatus can be used for various purposes. For instance, when the spherical 3D display device is detached from the docking station, the 3D display device can be used as a plaything such as a small ball.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A three-dimensional (3D) content reproduction apparatus comprising:
a spherical display device which reproduces 3D content; and
a docking station which provides the 3D content, or the 3D content and metadata of the 3D content received from one of a web server and a storage unit to the spherical display device.

2. The 3D content reproduction apparatus of claim 1, wherein the spherical display device is driven based on movement of the display device, or the movement and touch of the display device.

3. The 3D content reproduction apparatus of claim 1, wherein, if it is determined that 3D content to be displayed is intended for users under a predetermined age, the spherical display device outputs a low-pitched sound of a predetermined frequency.

4. The 3D content reproduction apparatus of claim 1, wherein, if information indicating that the spherical display device is detached from the docking station is received, the display device is turned off.

5. The 3D content reproduction apparatus of claim 1, wherein the spherical display device further displays 3D select information on reproducible 3D content.

6. The 3D content reproduction apparatus of claim 5, wherein, if the 3D content reproduction apparatus is a 3D electronic book (e-book) device, the 3D content is 3D e-book data and the 3D select information is information on selectable 3D e-books.

7. The 3D content reproduction apparatus of claim 1, wherein, if the spherical display device is detached from the docking station and the movement of the spherical display device is detected, the spherical display device displays one of a 3D moving image and a 3D still image which are previously stored.

8. The 3D content reproduction apparatus of claim 1, wherein the spherical display device outputs audio data.

9. The 3D content reproduction apparatus of claim 1, wherein, if the display device is not moved or touched for a predetermined period of time while a timer mode for the display device is set, the spherical display device is turned off.

10. The 3D content reproduction apparatus of claim 1, wherein the spherical display device comprises:
a user input analyzing unit which analyzes an input based on movement of the spherical display device, or the movement and touch of the spherical display device;
a wireless communication unit is communicates with the docking station;
a storage unit in which stores the 3D content and audio data corresponding to the 3D content;
a display unit which displays the 3D content in three-dimensions;
an audio output unit which outputs the audio data; and
a control unit which controls the spherical display device.

11. The 3D content reproduction apparatus of claim 10, wherein the storage unit further stores at least one of a 3D moving image and a 3D still image,
wherein, if the movement of the spherical display device is detected by the user input analyzing unit while the spherical display device is detached from the docking station, the control unit controls the display unit to display one of the 3D moving image and the 3D still image.

12. The 3D content reproduction apparatus of claim 1, wherein the docking station comprises a detecting unit which detects whether the spherical display device is attached to or detached from the docking station, and transmits a detection result to the spherical display device.

13. A method of controlling a three-dimensional (3D) content reproduction apparatus which comprises a spherical display device and a docking station, the method comprising:
receiving 3D content, or the 3D content and metadata from one of a web server and a storage unit;
if the 3D content is requested by the spherical display device, transmitting the 3D content, or the 3D content and the metadata to the spherical display device; and
controlling the spherical display device to reproduce the 3D content based on a control signal input by the docking station and movement of the spherical display device or the movement and touch of the spherical display device.

14. The method of claim 13, wherein, if the 3D content is intended for users under a predetermined age, the controlling the spherical display device to produce the 3D content comprises outputting a sound of a predetermined frequency.

15. The method of claim 13, wherein, if it is determined that the spherical display device is detached from the docking station, the controlling the spherical display device to produce the 3D content comprises turning off the spherical display device.

16. The method of claim 13, wherein, if the movement of the spherical display device is detected while the spherical display device is detached from the docking station, the controlling the spherical display device to produce the 3D content comprises displaying one of a 3D moving image and a 3D still image which are previously stored.

17. The method of claim 13, wherein, if the 3D content reproduction device is a 3D electronic-book (e-book) device, the 3D content is 3D e-book data.

18. The method of claim 13, further comprising detecting whether the spherical display device is attached to or detached from the docking station.

19. The method of claim 13, further comprising storing the received 3D content, or the received 3D content and the metadata in the docking station,
wherein the transmitting the 3D content, or the 3D content and the metadata to the spherical display device comprises transmitting the 3D content, or the 3D content and the metadata stored in the docking station to the spherical display device.

20. A three-dimensional (3D) content reproduction apparatus comprising:
a spherical display device which reproduces 3D content; and
a docking station to which the spherical display device is mounted,
wherein the spherical display device receives 3D content, or the 3D content and metadata of the 3D content from one of a web server and a storage unit.

21. A method of controlling a three-dimensional (3D) content reproduction apparatus which comprises a spherical display device and a docking station, the method comprising:
receiving 3D content, or the 3D content and metadata from one of a web server and a storage unit using the spherical display device; and
controlling the display device to reproduce the 3D content based on a control signal input by the docking station and movement of the spherical display device or the movement and touch of the spherical display device.
